(19) United States
(12) Patent Application Publication
(10) Pub. No.: US 2011/0145374 A1
(43) Pub. Date: Jun. 16, 2011

(54) COMMUNICATION SYSTEM FOR SUPPORTING COMMUNICATION BETWEEN DISTRIBUTED MODULES IN DISTRIBUTED COMMUNICATION NETWORK AND COMMUNICATION METHOD USING THE SAME

(75) Inventor: Keun-Jae LEE, Suwon-si (KR)

(73) Assignee: SAMSUNG ELECTRONICS CO., LTD., Suwon-si (KR)

(21) Appl. No.: 12/939,786

(22) Filed: Nov. 4, 2010

(30) Foreign Application Priority Data
Dec. 10, 2009 (KR) 10-2009-0122609

(51) Int. Cl. G06F 15/177

(52) U.S. Cl. 709/220

(57) ABSTRACT

A software system capable of enabling efficient communication between an application and an operating environment in a heterogeneous network is provided. A distributed processing system adopting the software system may obtain optimized latency during a network communication between distributed software modules.

### CROSS-REFERENCE TO RELATED APPLICATION(S)

This application claims the benefit under 35 U.S.C. §119(a) of Korean Patent Application No. 10-2009-0122609, filed on Dec. 10, 2009, the entire disclosure of which is incorporated herein by reference for all purposes.

### BACKGROUND

1. Field

The following description relates to a software system allowing efficient communication between an application and an operating environment, and more particularly, to a message publish/subscribe service mechanism for supporting a communication environment optimized in latency between distributed modules when the complexity of a software system is high and the number of software modules is high and therefore triggers the need for distributed process in multiple personal computers.

2. Description of the Related Art

A publish/subscribe service of a communication middleware improves the performance of modules in terms of a software architecture through a decoupling between modules by separating a message sending module from a message receiving module.

That is, a sending module, such as a message publisher, only publishes a message through a designated distributed processing module, such as a message broker or a distribution server, without any knowledge of a receiving module such, as a message subscriber. In addition, the receiving module also subscribes a message from the distributed processing module only using information about the message without any knowledge of the sending module.

Such communication middleware has been focused on message transmission, resulting in a lack of consideration of latency, and having a restriction on applying to a system in which real-time features are highly regarded.

### SUMMARY

In one general aspect, there is provided a communication system for supporting communication between distributed modules in a distributed computing communication network, the communication system including: a sending module configured to generate and send a message, a receiving module configured to receive the message sent from the sending module, and one or more distributed processing modules communicatively connected between the sending module and the receiving module, the distributed processing modules being configured to: create a transmission path, and relay a message through the transmission path.

The communication system may further include a module connection unit including location information of the distributed processing modules, the module connection unit being configured to provide the sending module or the receiving module with one of the distributed processing modules producing a smallest difference in location information from the sending module or the receiving module, in which the difference in location information is identified by performing location information matching on each of the distributed processing modules, with respect to each of: the sending module and the receiving module.

In the communication system, the module connection unit may: further include internet protocol (IP) addresses of the distributed processing modules, and be further configured to provide the sending module or the receiving module with one of the distributed processing modules producing a smallest difference in location value from the sending module or the receiving module, in which the difference in location value is identified by performing internet protocol (IP) longest prefix matching on each of the distributed processing modules with respect to each of the sending module and the receiving module.

In the communication system, the module connection unit may: further include one of: a topic list configured to record identification information about a message to be sent from the sending module, or a topic list which records identification information about a message desired by the receiving module, and be further configured to provide a distributed processing module connected to the receiving module with another distribution module, which includes location information similar to location information of the distributed processing module connected to the receiving module while retaining a topic list recording identification information about a message needed by the receiving module, in which the location information is identified by performing location information matching on distributed processing modules.

In the communication system, in response to the distributed processing module connected to the receiving module not including a topic list recording identification information about a message needed by the receiving module, the distributed processing module may be further configured to: distribute a topic query for the message needed by the receiving module, and connect with a distributed processing module producing a smallest difference in time between the sending of the topic query and a receiving of a reply to the topic query.

In the communication system: in response to the communication network being a single communication network, the topic query is broadcasted in the single communication network, and in response to the communication network being formed by multiple communication networks coupled to each other, the topic query may be sent to distributed processing modules of the multiple communication networks.

In another general aspect, there is provided a communication method for a communication system, including a sending module, a receiving module, a distributed processing module, and a module connection unit, and supporting communication between distributed modules in a distributed computing communication network, the communication method including: in response to a distributed processing module connected to the receiving module not including a topic list recording a message desired by the receiving module, at the distributed processing module connected to the receiving module, distributing a topic query for the message needed by the receiving module in the communication network, at the distributed processing module connected to the receiving module, receiving replies in response to the request message from distributed processing modules in the communication network, and connecting the distribution process connected to the receiving module to a distributed processing module which produces a smallest difference in time between the sending of the topic query and the receiving of the reply.

The communication method may further include: at the sending module, requesting the module connection unit to provide the sending module with a distributed processing module to deliver a message generated by the sending module, and at the module connection unit, selecting and providing a distributed processing module having an internet protocol (IP) frequency band closer to an IP frequency band of the sending module.

The communication method may further include: at the receiving module, requesting the module connection unit to provide a distributed processing module to relay a message needed by the receiving module, and at the module connection unit, selecting and providing a distributed processing module which produces a smallest difference in IP address from IP address of the receiving module.

In the communication method, in the distributing of the topic query: in response to the communication network being a single communication network, the topic query may be broadcasted in the single network, and in response to the communication network being formed by multiple communication networks coupled to each other, the topic query may be sent to distributed processing modules of the multiple communication networks, the distribution processing module having the topic list.

In the communication method the connecting of the distributed processing modules may include: recording topic query sending time at which the topic query is sent, recording reply receiving time at which the reply to the topic query is received, and obtaining a distributed processing module, which has sent a reply producing a smallest difference in time between the sending of the topic query and the receiving of the reply, by use of the recorded topic query sending time and the replay receiving time.

In another general aspect, there is provided a computer-readable information storage medium for storing a program to cause one or more computers to implement a communication method for a communication system, including a sending module, a receiving module, a distributed processing module, and a module connection unit, and supporting communication between distributed modules in a distributed computing communication network, including: in response to a distributed processing module connected to the receiving module not including a topic list recording a message desired by the receiving module, at the distributed processing module connected to the receiving module, distributing a topic query for the message needed by the receiving module in the communication network, at the distributed processing module connected to the receiving module, receiving replies in response to the request message from distributed processing modules in the communication network, and connecting the distribution process connected to the receiving module to a distributed processing module which produces a smallest difference in time between the sending of the topic query and the receiving of the reply.

The computer-readable information storage medium may further include: at the sending module, requesting the module connection unit to provide the sending module with a distributed processing module to deliver a message generated by the sending module, and at the module connection unit, selecting and providing a distributed processing module having an internet protocol (IP) frequency band closer to an IP frequency band of the sending module.

The computer-readable information storage medium may further include: at the receiving module, requesting the module connection unit to provide a distributed processing module to relay a message needed by the receiving module, and at the module connection unit, selecting and providing a distributed processing module which produces a smallest difference in IP address from IP address of the receiving module.

In the computer-readable information storage medium, in the distributing of the topic query: in response to the communication network being a single communication network, the topic query may be broadcasted in the single network, and in response to the communication network being formed by multiple communication networks coupled to each other, the topic query is sent to distributed processing modules of the multiple communication networks, the distribution processing module having the topic list.

In the computer-readable information storage medium, the connecting of the distributed processing modules may include: recording topic query sending time at which the topic query is sent, recording reply receiving time at which the reply to the topic query is received, and obtaining a distributed processing module, which has sent a reply producing a smallest difference in time between the sending of the topic query and the receiving of the reply, by use of the recorded topic query sending time and the replay receiving time.

Other features and aspects may be apparent from the following detailed description, the drawings, and the claims.

### BRIEF DESCRIPTION OF THE DRAWINGS

FIG. 1 shows an example of a configuration of a communication system.

FIG. 2 shows an example of a total transmission time of the communication system that is improved in terms of latency.

FIG. 3 shows an example of a message publish/subscribe service architecture of the communication system.

FIG. 4 shows an example of a process of passing a message between a sending module and a receiving module in a communication system.

FIG. 5 shows an example in which a message path is created between a sending module and a receiving module of a communication system and a message is delivered to another receiving module.

FIG. 6 shows an example in which a message path between a sending module and a receiving module of a communication system is created in one of communication networks that are coupled to each other and then a message is sent to a receiving module residing in another communication network.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

Examples will be described with reference to accompanying drawings in detail.

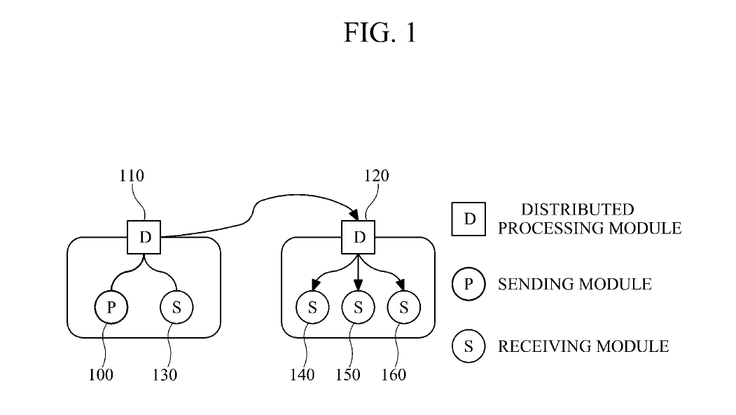

FIG. 1 shows an example of a configuration of a communication system.

As shown in FIG. 1, the communication system may include a sending module (P) 100; distributed processing modules (D) 110 and 120; and receiving modules (S) 130, 140, and 150. In this example, “P” refers to a publisher, “D” refers to a distributor, and “S” refers to a subscriber.

The sending module 100 and the receiving module 130 may exist in a first local area together with the distributed processing module 110. The receiving modules 140, 150, and 160 may exist in a second local area together with the distributed processing module 120.

The “local area” represents an area specified for a mobile terminal including one or more modules, e.g., modules 100, 110, 120, 130, 140, 150, and 160.

The sending module 100 may generate a message and may send the generated message to a distributed processing module optimized in latency with respect to the sending module 100, for example, the distributed processing module 110.

The latency optimization may involve selecting the nearest module within a communication network in consideration of the deployment of individual modules. Two types of method of detecting the nearest module may be employed. For example, the nearest module may be selected by recognizing location information that is identified through internet protocol (IP) longest prefix matching between modules. Alternatively, the nearest module may be selected based on the module producing the shortest time taken to deliver a message between modules.

The “message” refers to a message including general data, that is, a message including additional information allowing the message to be categorized.

The message may be directly sent to the receiving module 130, desiring the message, through the distributed processing module 110 in the first location area.

In addition, the receiving modules 140 and 150, desiring the message in the second local area, may be connected to the distributed processing module 120 in the second local area, in which the distributed processing module 120 may be optimized in latency. Accordingly, the distributed processing module 110 of the first local area may deliver the message sent from the sending module 100 to the distributed processing module 120 of the second local area. The distributed processing module 120 may send the received message to the receiving modules 140, 150, and 160 existing in the second local area. That is, a transmission path may exist between the distributed processing module 110 of the first local area and the distributed processing module 120 of the second local area, and a message relay may be enabled between distributed processing modules of different local areas.

In this regard, according to the example of the communication system, the latency of the overall system including the transmission process between distributed process modules may be more optimized.

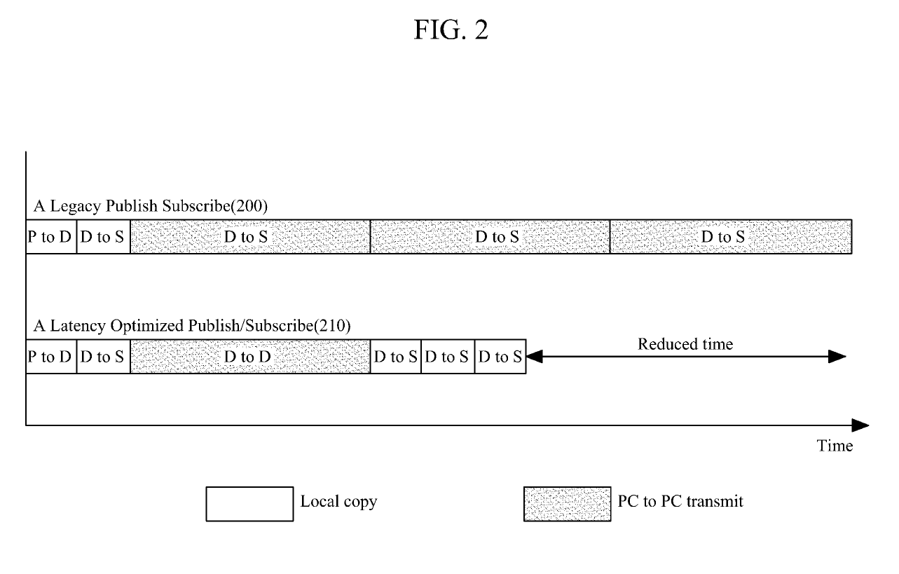

FIG. 2 shows an example of the total transmission time of the communication system that is improved in terms of latency.

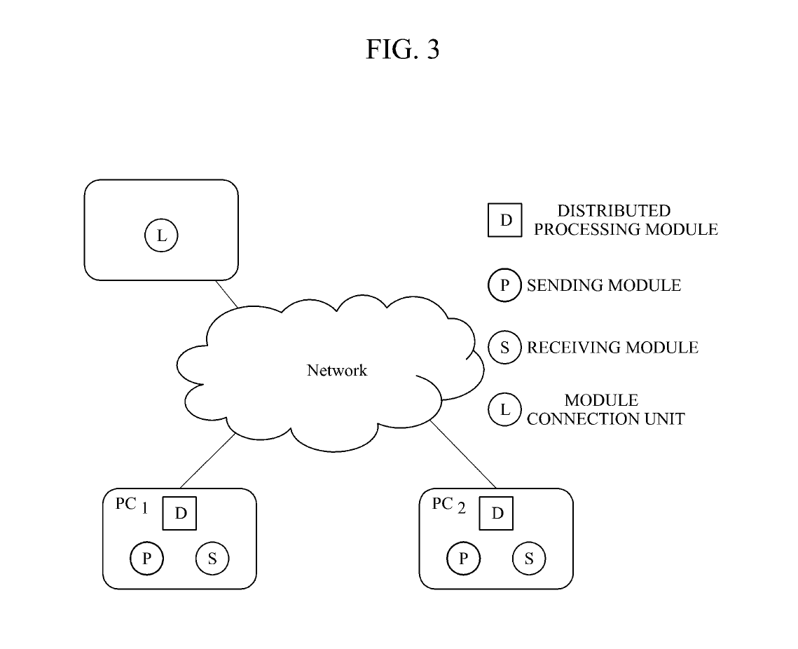

In an example in which a message is directly sent from the distributed processing module 110 to the receiving modules 140, 150, and 160, a terminal to a terminal (e.g., a first personal computer (PC) PC₁ to a second PC PC₂ in FIG. 3) transmission may occur other than a transmission in a local area. Accordingly, as shown with reference numeral 200 that denotes a legacy publish/subscribe operation 200, a great amount of time may be required for a D to S message transmission from the distributed processing module to the receiving module.

However, as shown with reference numeral 210 in FIG. 2 that denotes a latency optimized publish/subscribe operation, the example of the communication system may include a D to D transmission between the distributed processing module 110 to the distributed processing module 120. The transmission between the distributed processing modules 110 and 120 corresponds to a terminal to terminal transmission, which may lead to a relatively large transmission time. However, the transmission between the distributed process module 120 to each of the receiving modules 140, 150, and 160 corresponds to a local copy, requiring a relatively small transmission time.

Accordingly, the total transmission time may be significantly reduced by “Reduced time” shown in FIG. 2.

As shown in FIG. 2, in the legacy optimized publish/subscribe operation 200, the terminal to terminal transmission (e.g., PC₁ to PC₂ transmission) may occur three times. However, in the latency optimized publish/subscribe operation 210, the terminal to terminal transmission (e.g., PC₁ to PC₂ transmission) may occur only one time, so that the total time required to deliver a message to respective receiving modules 130, 140, and 150 may be reduced. Accordingly, the latency of the entire system may be improved.

FIG. 3 shows an example of a message publish/subscribe service architecture of the communication system.

As shown in FIG. 3, the communication system may include a distributed processing module, a sending module, a receiving module, and a module connection unit.

The sending module may send a message over a communication network. At least one receiving module may receive the message. At least one distributed processing module may relay the message between the sending module and the receiving module.

In addition, the module connection unit may provide the sending module and the receiving module with a latency optimized distributed processing module.

The module connection unit may manage location information of the distributed processing module existing in the communication network, may provide the sending/receiving modules with a distributed processing module producing the smallest latency in response to a request by the sending/receiving modules, and may support connection between distributed processing modules having the optimum latency when a transmission path between distributed processing modules is created.

In addition, the module connection unit may retain and manage a topic list which records identification information about a message to be sent from the sending module, and a topic list which records identification information about a message to be received to the receiving module.

The topic list may contain names of respective messages corresponding to identification information that may be used to identify a message conveyed through the distributed processing module. The topic list may include a topic list recording identification information of messages that are generated by a sending module or a topic list recording identification information of message that are needed by a receiving module.

The distributed processing module may manage its own topic list, and may maintain the topic list, a topic list of a sending module, and a topic list of a receiving module.

Message publish/subscribe service may be provided based on the above information. If a distributed processing module receives a message from a sending module, the distributed processing module may relay the message to a receiving module requiring the message.

The distributed processing module may connect with another nearby distributed processing module. For example, the distributed processing module may subscribe to an external receiving module to create a transmission path between modules. Such a transmission path between modules may enable a message to be relayed between distributed processing modules.

In addition, if the distributed processing module receives a topic query of requesting a message from a another nearby distributed processing module, the distributed processing module may check if the corresponding message exists in its own topic list. If the corresponding message exists in its own topic list, the distributed processing module may deliver a reply to the topic query.

The sending module may generate a message and register the generated message on a topic list of a distributed processing module connected to the sending module.

The receiving module may register a desired message on a topic list of a distributed processing module connected to the receiving module, and may receive the message sent by the distributed processing module.

As described above, the transmission path between distributed processing modules may be created through a topic query that is directly issued by the distributed processing modules. However, if the module connection unit has information about distributed processing modules and information about a topic list retained in the corresponding distributed processing modules, the transmission path between distributed processing modules may also be created by the module connection unit.

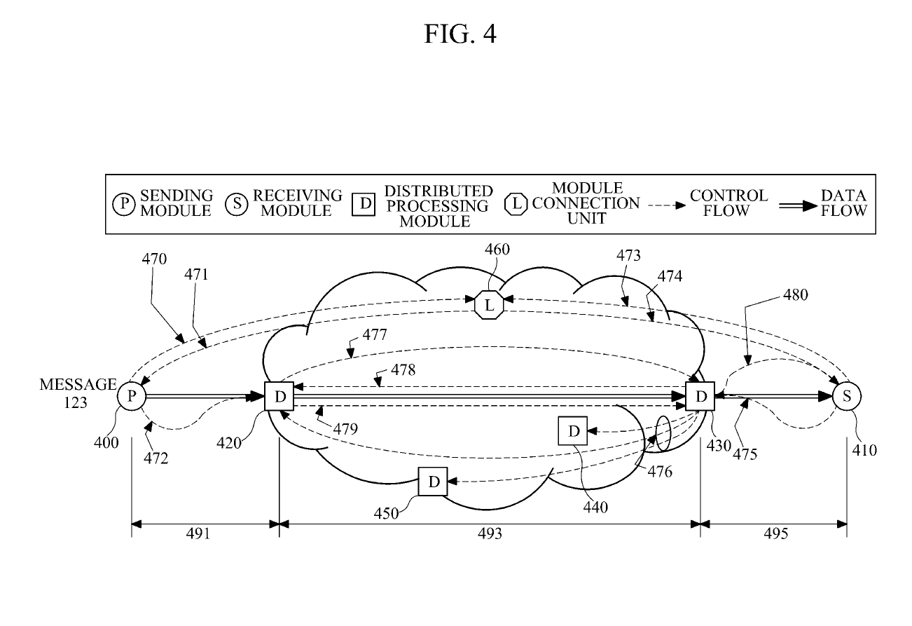

FIG. 4 shows an example of a process of passing a message between a sending module and a receiving module in a communication system.

As shown in FIG. 4, a sending module 400; a receiving module 410; distributed processing modules 420, 430, 440. and 450; and a module connection unit 460 may exist in a communication network.

In an example in which the sending module 400 creates a message 123, at operation 470, the sending module 400 may request the module connection unit 460 to select a distributed processing module which serves to relay the message 123.

The module connection unit 460 may select a distributed processing module optimized in latency of the entire system with respect to the sending module 400 among the distributed processing modules 420, 430, 440, and 450 existing in the communication network, for example, selects the distributed processing module 420. After that, in operation 471, the module connection unit 460 may provide the selected distributed processing module 420 to the sending module 400.

A latency optimized distributed processing module to be connected to the sending module 400 may be found through an IP longest prefix matching According to IP longest prefix matching, a distributed processing module having the closest location information to that of the sending module 400 is found using IP address based on internet protocol. Alternatively, the distributed processing module 420 may be found by measuring the time to sending/receiving a message.

In operation 472, the sending module 400, which may be provided with the distributed processing module 420 by the module connection unit 460, may request the distributed processing module 420 to register the message 123 on the topic list retained in the distributed processing module 420.

The distributed processing module 420 may register the sending module 400 and the message 123 on its own topic list, and may prepare to relay the message 123.

In operation 473, the receiving module 410 may request the module connection unit 460 to select a distributed processing module to deliver a desired message. The module connection unit 460 may select a distributed processing module, optimized in latency of the entire system with respect to the receiving module 410, among the distributed processing modules 420, 430, 440, and 450 existing in the communication network. For example, module connection unit 460 may select the distributed processing module 430. After that, in operation 474, the module connection unit 460 may provide the selected distributed processing module 430 to the receiving module 410.

A latency optimized distributed processing module to be connected to the receiving module 410 may be found through an IP longest prefix matching. According to the IP longest prefix matching, a distributed processing module having the closest location information to that of the receiving module 410 is found using IP address based on internet protocol. Alternatively, the distributed processing module 430 may be found by measuring the time to sending/receiving a message.

In operation 475, the receiving module 410, which may be provided with the distributed processing module 430 by the module connection unit 460, may request the distributed processing module 430 to register the desired message 123 on the topic list retained in the distributed processing module 430.

If the message 123 exists in the topic list of the distributed processing module 430, the distributed processing module 430 may register the receiving module 410 on its own topic list and may prepare to deliver the message 123.

In operation 476, if the message 123 does not exist on the topic list of the distributed processing module 430, the distributed processing module 430 may broadcast the topic query of requesting the message 123 in the communication network.

Each of the distributed processing modules 420, 440, and 450, having received the topic query, may check if the message exists in its own respective topic list. In operation 477, a distributed processing module having a topic list regarding the message 123 may send the distributed processing module 430 a reply in response to the topic query.

The distributed processing module 430 may make a request for connecting with the distributed processing module 420, which may produce a reply arriving at the distributed processing module 430 earlier than any other replies. For example, in operation 478, the distributed processing module 430 may request to be subscribed as an external receiving module.

The earliest reply may be determined by recognizing the difference in time between the sending of the topic query and the arrival of the reply. However, the method of determining the earliest reply is not limited thereto.

In operation 479, the distributed processing module 420, having received the request for connection, may register the distributed processing module 430 as an external receiving module, and may send a reply on registration.

The connection between the distributed processing module 420 and the distributed processing module 430 may be completed, creating a transmission path the distributed processing module 420 and the distributed processing module 430. As a result, at operation 480, a final message transmission path may be established such that the message 123 is delivered from the sending module 400 to the receiving module 410 through the transmission path between the distributed processing modules 420 and 430.

The sending module 400 may be connected to the latency optimized distributed processing module 420, as shown with reference numeral 491. The receiving module 410 may be connected to the latency optimized distributed processing module 430, as shown with reference numeral 495. In addition, both of the distributed processing modules 420 and 430 may maintain a latency optimized relationship as shown with reference numeral 493. In this regard, the overall system may be more optimized in latency.

According to another example in which a module connection unit does not exist, a sending module or a receiving module may relay a message by use of a distributed processing module which may be designated directly by a user, or a latency optimized distributed processing module which may be found out by the sending module or the receiving module.

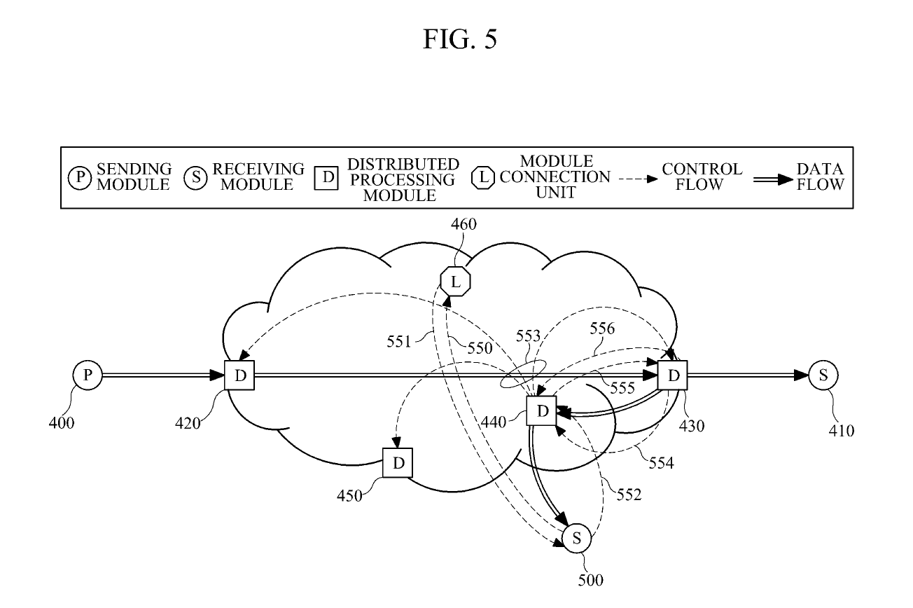

FIG. 5 shows an example in which a message path is created between a sending module and a receiving module of a communication system and a message is delivered to another receiving module.

In an example in which a transmission path between the sending module 400 and the receiving module 410 has already been established as shown in the example of FIG. 4, when a receiving module 500 requests the message 123, a process of passing the message 123 may be as follows.

In operation 550, the receiving module 500 may request the module connection unit 460 to select a distributed processing module to deliver a message.

In operation 551, the module connection unit 460 may select the distributed processing module 440 as a latency optimized distributed processing module to be connected with the receiving module 500, and may provide the receiving module 500 with the selected distributed processing module 440. A latency optimized distributed processing module may be found through IP longest prefix matching. According to the IP longest prefix matching, a distributed processing module having the closest location information to that of the receiving module 500 is found using IP address based on internet protocol (IP). Alternatively, the distributed processing module 440 may be found by measuring the time to sending/receiving a message.

In operation 552, the receiving module 500, which may be provided with the distributed processing module 440 by the module connection unit 460, may request the distributed processing module 440 to register the desired message 123 on a topic list of the distributed processing module 440.

If the message 123 exists on the topic list of the distributed processing module 440, the distributed processing module 440 may register the receiving module 500 and the message 123 and may send the message 123.

In operation 553, if the message does not exist on the topic list of the distributed processing module 440, the distributed processing module 440 may broadcast a topic query of requesting the message 123 in the communication network.

Each of the distributed processing modules 420, 430, and 450, having received the topic query, may check if the message 123 exists in its own topic list. In operation 554, a distributed processing module, having a topic list regarding the message 123, may send the distributed processing module 440 a reply in response to the topic query which may be sent by the distributed processing module 440.

The distributed processing module 440 may make a request for connecting with the distributed processing module 430 producing a reply which arrives at the distributed processing module 440 earlier than any other topic replies. For example, in operation 555, the distributed processing module 440 may request to be subscribed as an external receiving module. In operation 556, the distributed processing module 430, having received the request for connection, may register the distributed processing module 440 as an external receiving module, and may send a reply on registration.

The earliest reply may be determined by recognizing the difference in time between the sending of the topic query and the arrival of the reply. However, the method of determining the earliest reply is not limited thereto.

In this manner, the connection between the distributed processing module 440 and the distributed processing module 430 may be completed, creating a transmission path between the distributed processing module 440 and the distributed processing module 430. As a result, an overall message transmission path may be established such that the message 123 is delivered from the sending module 400 through the transmission path between the distributed processing modules 440 and 430.

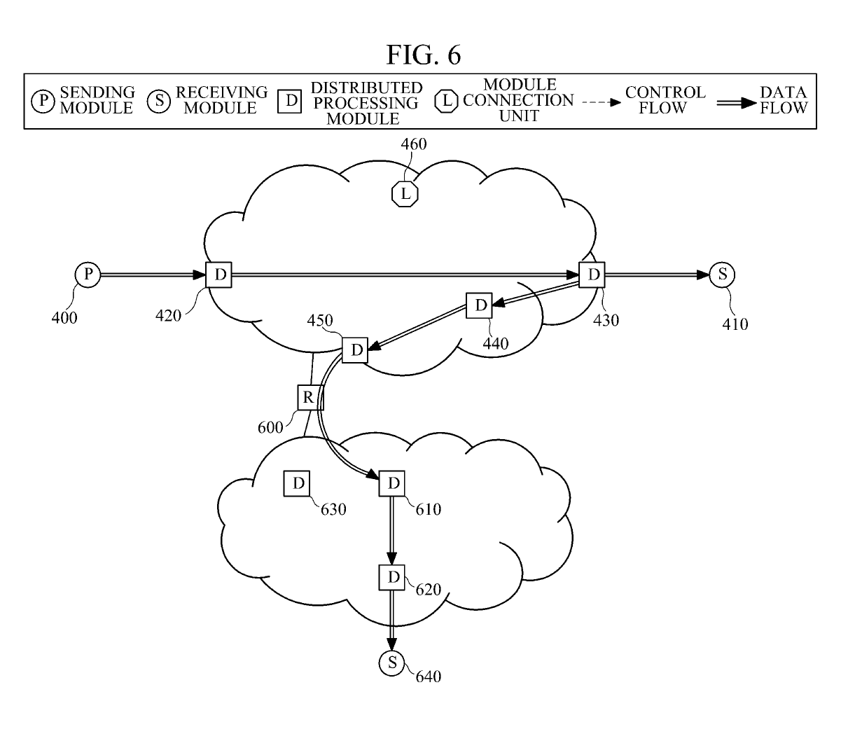

FIG. 6 shows an example in which a message path between a sending module and a receiving module of a communication system is created in one of communication networks that are coupled to each other and then a message is sent to a receiving module residing in another communication network.

In an example in which a single communication network is connected to another communication network through a router R 600, and a transmission path of the message 123 has been created between the sending module 400 and the receiving module 410 in the single communication network as shown in the example of FIG. 4, when a receiving module 640 existing in the other communication network requests the message 123, a process of passing the message 123 may be as follows.

The receiving module 640 may request the module connection unit 460 to select a distributed processing module to deliver the message. The module connection unit 460 may select a distributed processing module 620 as a latency optimized distributed processing module to be connected with the receiving module 640, and may provide the receiving module 640 with the selected distributed processing module 620. A latency optimized distributed processing module to be connected with the receiving module 500 may be found through an IP longest prefix matching. According to the IP longest prefix matching, a distributed processing module having the closet location information to that of the receiving module 640 is found using IP addresses based on internet protocol (IP). Alternatively, the distributed processing module 620 may be found by measuring the time to sending/receiving a message.

The receiving module 640, which may be provided with the distributed processing module 620 by the module connection unit 460, may request the distributed processing module 620 to register the desired message 123 on a topic list of the distributed processing module 620.

If the message 123 exists on the topic list of the distributed processing module 620, the distributed processing module 620 may register the receiving module 640, and may prepare to send the message 123.

If the message 123 does not exist on the topic list of the distributed processing module 620, the distributed processing module 620 may unicast a topic query requesting the message 123 to other distributed processing modules, each existing in the entire communication network.

Each of the distributed processing modules 420, 430, 440, 450, 610, and 630, having received the topic query, may check if the message 123 exists in its own topic list. A distributed processing module, having a topic list regarding the message 123, may send the distributed processing module 620 a reply in response to the topic query which may be sent by the distributed processing module 620.

The distributed processing module 620 may measure the time required to receive the topic reply by recording the time at which the topic query is sent to the respective distributed processing modules. This process may be to better optimize the latency of the system in creating a transmission path between distributed processing modules. The method of optimizing latency is not limited thereto and may be implemented in various schemes.

The distributed processing module 620 may make a request for connecting with the distributed processing module 610, which may produce the smallest time to receive the reply. For example, the distributed processing module 620 may request to be subscribed as an external receiving module. The distributed processing module 610, having received the request for connection, may register the distributed processing module 620 as an external receiving module, and may send a reply of registration.

In this manner, the connection between the distributed processing module 610 and the distributed processing module 620 may be completed, creating a transmission path between the distributed processing modules 620 and 610. As a result, an overall message transmission path may be established such that the message 123 may be delivered from the sending module 400 to the receiving module 640 through a plurality of distributed processing modules 420, 430, 440, 450, 610, and 620.

The transmission path between the distributed processing modules 610 and 620 may be removed upon a request by the sending module or the receiving module. The process of removing the transmission path may be achieved through the reverse sequences of the message subscription process. A process flow of removing the transmission path is as follows.

For example, in stage 1, a receiving module may send a distributed processing module a request for unsubscribing a message.

In stage 2, the distributed processing module may delete the receiving module which has made the unsubscribe request from a list of receiving modules, and, may check if another receiving module in need of the corresponding message exists on the list of receiving modules.

In stage 3, the distributed processing module may check if another receiving module in need of the corresponding message exists on a list of external receiving modules.

In stage 4, if no receiving module in need of the corresponding message exists in the list of internal receiving modules and the list of external receiving modules, the distributed processing module may delete an entry corresponding to the message from a topic list. Then, the distributed processing module may search through a list of external sending modules, may send a unsubscribe request to a sending module that produces the corresponding message, and may delete the corresponding sending module from the list of external sending modules.

In stage 5, the distributed processing module, having received the unsubscribe request, may delete the corresponding receiving module from the list of external receiving modules, and, may search if another receiving module in need of the corresponding message exists in the list of receiving modules and the list of external receiving modules.

In stage 6, if no receiving module in need of the corresponding message exists in the list of internal receiving modules and the list of external receiving modules, and, a topic list recording the corresponding message exists in the list of external sending modules, the process of removing the transmission path may return to stage 4.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

As a non-exhaustive illustration only, the device described herein may refer to mobile devices such as a cellular phone, a personal digital assistant (PDA), a digital camera, a portable game console, and an MP3 player, a portable/personal multimedia player (PMP), a handheld e-book, a portable tablet and/or laptop PC, a global positioning system (GPS) navigation, and devices such as a desktop PC, a high definition television (HDTV), an optical disc player, a setup and/or set-top box, and the like, consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of example embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A communication system for supporting communication between distributed modules in a distributed computing communication network, the communication system comprising:
a sending module configured to generate and send a message;
a receiving module configured to receive the message sent from the sending module; and
one or more distributed processing modules communicatively connected between the sending module and the receiving module, the distributed processing modules being configured to:
create a transmission path; and
relay a message through the transmission path.

2. The communication system of claim 1, further comprising a module connection unit comprising location information of the distributed processing modules, the module connection unit being configured to provide the sending module or the receiving module with one of the distributed processing modules producing a smallest difference in location information from the sending module or the receiving module, in which the difference in location information is identified by performing location information matching on each of the distributed processing modules, with respect to each of: the sending module and the receiving module.

3. The communication system of claim 2, wherein the module connection unit:
further comprises internet protocol (IP) addresses of the distributed processing modules; and
is further configured to provide the sending module or the receiving module with one of the distributed processing modules producing a smallest difference in location value from the sending module or the receiving module, in which the difference in location value is identified by performing internet protocol (IP) longest prefix matching on each of the distributed processing modules with respect to each of the sending module and the receiving module.

4. The communication system of claim 2, wherein the module connection unit:
further comprises one of:
a topic list configured to record identification information about a message to be sent from the sending module; or
a topic list which records identification information about a message desired by the receiving module; and
is further configured to provide a distributed processing module connected to the receiving module with another distribution module, which comprises location information similar to location information of the distributed processing module connected to the receiving module while retaining a topic list recording identification information about a message needed by the receiving module, in which the location information is identified by performing location information matching on distributed processing modules.

5. The communication system of claim 1, wherein, in response to the distributed processing module connected to the receiving module not comprising a topic list recording identification information about a message needed by the receiving module, the distributed processing module is further configured to:
distribute a topic query for the message needed by the receiving module; and
connect with a distributed processing module producing a smallest difference in time between the sending of the topic query and a receiving of a reply to the topic query.

6. The communication system of claim 5, wherein:
in response to the communication network being a single communication network, the topic query is broadcasted in the single communication network; and
in response to the communication network being formed by multiple communication networks coupled to each other, the topic query is sent to distributed processing modules of the multiple communication networks.

7. A communication method for a communication system, including a sending module, a receiving module, a distributed processing module, and a module connection unit, and supporting communication between distributed modules in a distributed computing communication network, the communication method comprising:
in response to a distributed processing module connected to the receiving module not comprising a topic list recording a message desired by the receiving module, at the distributed processing module connected to the receiving module, distributing a topic query for the message needed by the receiving module in the communication network;
at the distributed processing module connected to the receiving module, receiving replies in response to the request message from distributed processing modules in the communication network; and
connecting the distribution process connected to the receiving module to a distributed processing module which produces a smallest difference in time between the sending of the topic query and the receiving of the reply.

8. The communication method of claim 7, further comprising:
at the sending module, requesting the module connection unit to provide the sending module with a distributed processing module to deliver a message generated by the sending module; and
at the module connection unit, selecting and providing a distributed processing module having an internet protocol (IP) frequency band closer to an IP frequency band of the sending module.

9. The communication method of claim 7, further comprising:
at the receiving module, requesting the module connection unit to provide a distributed processing module to relay a message needed by the receiving module; and
at the module connection unit, selecting and providing a distributed processing module which produces a smallest difference in IP address from IP address of the receiving module.

10. The communication method of claim 7, wherein, in the distributing of the topic query:
in response to the communication network being a single communication network, the topic query is broadcasted in the single network; and
in response to the communication network being formed by multiple communication networks coupled to each other, the topic query is sent to distributed processing modules of the multiple communication networks, the distribution processing module having the topic list.

11. The communication method of claim 7, wherein the connecting of the distributed processing modules comprises:
recording topic query sending time at which the topic query is sent;
recording reply receiving time at which the reply to the topic query is received; and
obtaining a distributed processing module, which has sent a reply producing a smallest difference in time between the sending of the topic query and the receiving of the reply, by use of the recorded topic query sending time and the replay receiving time.

12. A computer-readable information storage medium for storing a program to cause one or more computers to implement a communication method for a communication system, including a sending module, a receiving module, a distributed processing module, and a module connection unit, and supporting communication between distributed modules in a distributed computing communication network, comprising:
in response to a distributed processing module connected to the receiving module not comprising a topic list recording a message desired by the receiving module, at the distributed processing module connected to the receiving module, distributing a topic query for the message needed by the receiving module in the communication network;
at the distributed processing module connected to the receiving module, receiving replies in response to the request message from distributed processing modules in the communication network; and
connecting the distribution process connected to the receiving module to a distributed processing module which produces a smallest difference in time between the sending of the topic query and the receiving of the reply.

13. The computer-readable information storage medium of claim 12, further comprising:
at the sending module, requesting the module connection unit to provide the sending module with a distributed processing module to deliver a message generated by the sending module; and
at the module connection unit, selecting and providing a distributed processing module having an internet protocol (IP) frequency band closer to an IP frequency band of the sending module.

14. The computer-readable information storage medium of claim 12, further comprising:
at the receiving module, requesting the module connection unit to provide a distributed processing module to relay a message needed by the receiving module; and
at the module connection unit, selecting and providing a distributed processing module which produces a smallest difference in IP address from IP address of the receiving module.

15. The computer-readable information storage medium of claim 12, wherein, in the distributing of the topic query:
in response to the communication network being a single communication network, the topic query is broadcasted in the single network; and
in response to the communication network being formed by multiple communication networks coupled to each other, the topic query is sent to distributed processing modules of the multiple communication networks, the distribution processing module having the topic list.

16. The computer-readable information storage medium of claim 12, wherein the connecting of the distributed processing modules comprises:
recording topic query sending time at which the topic query is sent;
recording reply receiving time at which the reply to the topic query is received; and
obtaining a distributed processing module, which has sent a reply producing a smallest difference in time between the sending of the topic query and the receiving of the reply, by use of the recorded topic query sending time and the replay receiving time.
